(19) United States
(12) Patent Application Publication
(10) Pub. No.: US 2008/0238138 A1
(43) Pub. Date: Oct. 2, 2008

(54) Cocoon camper

(76) Inventor: Jacques Vallee, Valleyfield (CA)

Correspondence Address: Raymond M. Galasso;Galasso & Associates LP, P.O. Box 26503, Austin, TX, 78755-0503, US

(21) Appl. No.: 11/729,154

(22) Filed: Mar. 27, 2007

(51) Int. Cl. B60P 3/35

(52) U.S. Cl. 296/167

(57) ABSTRACT

Cocoon Camper is a two-unit camper consisting of a frontal vehicle and a rear camper section. The frontal vehicle and rear camper section are connected and locked together allowing the vehicle to drive as if it were a single unit. The rear camper section of Cocoon Camper overlaps the frontal vehicle on top with a section that locks in place and connects directly to the top of the frontal vehicle unit with supports. The rear camper also locks in place from the back of the frontal vehicle unit to fully connect and stabilize the vehicle. Cocoon Camper works by connecting the drive shaft from the frontal vehicle to the camper in order to drive the wheels of the camper section from the rear. Cocoon Camper makes this possible by allowing the rear wheels of the frontal vehicle unit to retract to provide the proper clearance. The frontal vehicle has a unique modified differential that includes a selector to activate the wheels on the frontal vehicle or the wheels on the camper unit.

### CROSS-REFERENCE TO RELATED APPLICATIONS

This United States Non-Provisional Patent Application does not claim priority to any United States Provisional Patent applications or any foreign patent applications.

### FIELD OF THE DISCLOSURE

The disclosures made herein relate generally to the automotive industry. The invention discussed herein is in the general classification of recreational vehicles and campers.

### BACKGROUND

Millions of people travel for vacation, utilizing a variety of vehicles. Trucks or vans with hitched trailers or campers along with RV's (recreational vehicles) are some of the most popular vehicles used for extended travel.

Unfortunately, normal hitched trailers and campers are difficult to turn and maneuver because they are simply linked to a towing vehicle's hitch ball. The cumbersome steering also leads to a greater likelihood of traffic accidents.

Traditional recreational vehicles and drivable campers solve the maneuverability problem but create other problems. For example, if the engine or other vital part of the recreational camper or drivable camper is in need of repair, the entire vehicle must be brought in for work. In addition, these traditional recreational vehicles are often extremely expensive.

Hence, there is a need in the art for an easy to use, affordable, safe and maneuverable camper that can be attached and detached from a frontal vehicle whenever necessary.

### SUMMARY OF THE DISCLOSURE

Cocoon Camper is a two-unit camper consisting of a frontal van and a camper section. The van and camper section are connected and locked together allowing the vehicle to drive as if it were a single unit. The rear camper section of Cocoon Camper overlaps the van on top with a section that locks in place and connects directly to the top of the van unit with supports. The rear camper also locks in place from the back of the van unit to fully connect and stabilize the vehicle.

The top of the camper section rises up via air or hydraulic cylinders to make sufficient head room inside when the vehicle is stationary. This extra space is provided by a fold-up canvas top section and includes an air vent for circulation.

Cocoon Camper works by connecting the drive shaft from the van to the camper in order to drive the rear wheels of the camper. Cocoon Camper makes this possible by allowing the rear wheels of the van unit to lift when the camper is in use to provide the proper clearance. The rear wheels of the van lift and lower using air cylinders that also double as the rear suspension when the van is being used independently. The van has a unique modified differential that includes a selector to activate the wheels on the van or the wheels on the camper unit. Obviously, this design only works for vehicles/vans that have rear wheel drive capabilities. The Cocoon Camper includes a gear box that swings on bearings to move the rear wheels of the van up or down. A brake would also be installed on the trailer and would be electrically activated.

The principal object of this invention is to provide a two-piece camper consisting of a rear camper unit and frontal vehicle whereby the rear camper unit can be firmly attached to the frontal vehicle rather than simply towed behind the frontal vehicle.

Another object of this invention is to provide an affordable and easily maneuvered two-piece camper that drives like a single unit.

Another object of this invention is to provide a rear camper unit that is easily attached and detached from the frontal vehicle so the frontal vehicle can be used independently.

Yet another object of this invention is to provide a two-piece camper that can be safely driven when the rear camper is attached to the frontal vehicle.

### BRIEF DESCRIPTION OF THE DRAWINGS

FIG. 1 depicts a perspective view of the preferred embodiment of the present invention.

FIG. 2 depicts a side view of the preferred attaching mechanism for the rear camper section and the frontal vehicle.

FIG. 3 depicts a side view of the rear axle of the frontal vehicle and the preferred embodiment of the air cylinders used to lift the rear wheels of the frontal vehicle.

FIG. 4 depicts a top cut away view of the drive train assembly of the rear camper section and frontal vehicle.

FIG. 5 depicts a frontal view of the preferred embodiment of the drive train assembly operatively connecting the frontal vehicle and the rear camper section.

### DETAILED DESCRIPTION OF THE DRAWINGS

Cocoon Camper consists of at least some of the following: a frontal vehicle and a rear camper section, an attaching mechanism to attach the frontal vehicle to the rear camper section, hydraulic cylinders to lift a canvas top of the rear camper section, air or hydraulic cylinders to lift the rear wheels of the frontal vehicle, a modified differential, an electronically activated brake on the rear camper section, and a unified drive train assembly to operatively connect the frontal vehicle and the rear camper section.

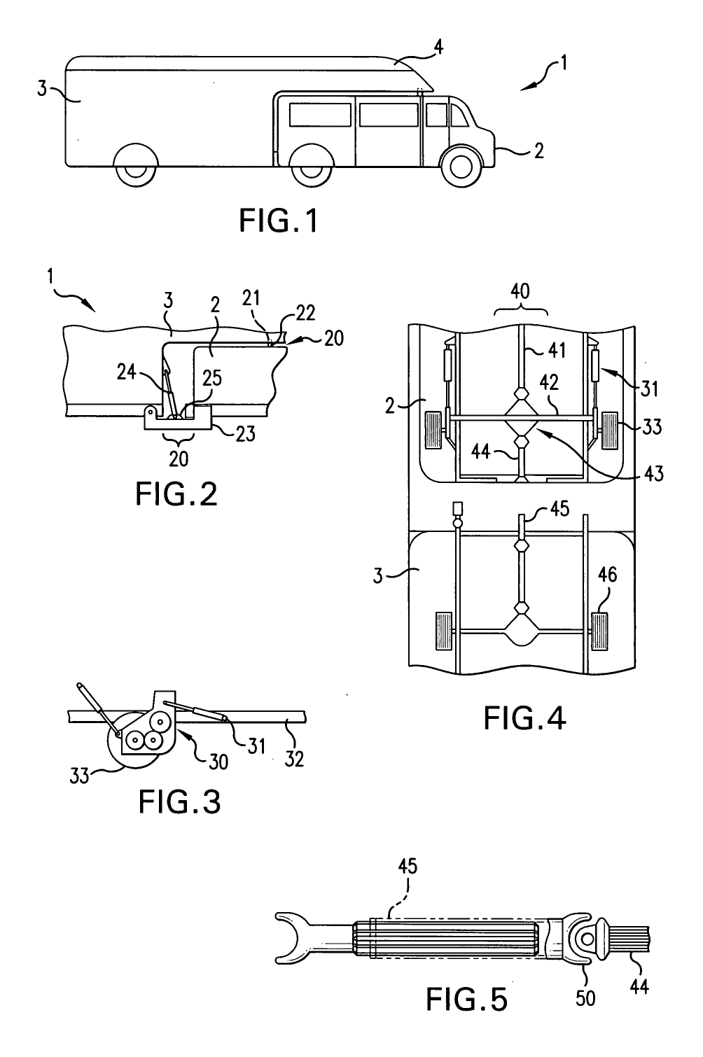

FIG. 1 depicts the preferred embodiment of a two-unit camper 1 consisting of a frontal van 2 and a rear camper section 3. The frontal van 2 and rear camper section 3 are made of materials well known in their respective arts. The design allows for the rear camper section 3 to overlap the top of the frontal van 2. The top of the rear camper section 3 rises up via air or hydraulic cylinders (not pictured) to make sufficient head room inside when the two-unit camper 1 is stationary. This extra space is provided by a fold-up canvas top section 4 that includes an air vent (not pictured) for circulation.

FIG. 2 depicts a side view of the preferred embodiment of the attaching mechanism 20. The frontal van 2 and rear camper section 3 are connected and locked together by the attaching mechanism 20 allowing the entire two-unit camper 1 drive as if it were a single unit. The rear camper section 3 overlaps the top of the frontal van 2 and utilizes two support rods 21 to connect the rear camper section 3 to a rack 22 on top of the frontal van 2. The attaching mechanism 20 also locks the rear camper section 3 in place from the back of the frontal van 2 to fully connect and stabilize the two-unit camper 1. A C-shaped metal bar 23 is bolted to the rear of the frontal van 2 and the front of the rear camper section 3. A chain 24 also attaches to the front of the rear camper section 3 on one end and to a hook 25 on the middle of the metal bar 23 on the other end to provide additional support.

FIG. 3 depicts a side view of the rear axle of the frontal van and the air cylinders used to lift the rear wheels of the frontal van. The rear axle includes a gear box 30 that swings on bearings (not pictured) to move the rear wheels 33 of the frontal van up or down. The gear box connects to air cylinders 31 that are bolted to the frame 32 of the frontal van. The rear wheels 33 of the frontal van are moved up when the rear camper section is attached to provide the necessary clearance.

FIG. 4 depicts a top cut away view of the drive train assembly 40 of the rear camper section 3 and frontal van 2. The front drive shaft 41 of the frontal van 2 is connected to the modified differential 43 on the rear axle 42 of the frontal van 2. The rear drive shaft 44 of the frontal van connects on one end to the rear axle 42 and on the other end to the rear camper section drive shaft 45. This design permits the rear wheels 46 of the rear camper section 3 to be controlled for easier handling.

As can be seen in FIG. 4, and previously discussed in conjunction with FIG. 3, the rear wheels 33 on the frontal van 2 lift and lower using air cylinders 31 that also double as the rear suspension when the frontal van 2 is in use without the rear camper section 3. The frontal van 2 has a unique modified differential 43 that includes a selector to activate the rear wheels 33 on the frontal van 2 or the rear wheels 46 on the rear camper section 3. A brake would also be installed on the rear camper section 3 and would be electrically activated.

FIG. 5 depicts a frontal view of the preferred embodiment of the drive train assembly operatively connecting the frontal van and the rear camper section. The rear camper section drive shaft 45 slides to permit it to extend and be connected to the rear drive shaft 44 of the frontal vehicle via a quick coupling 50. In the preferred embodiment, the rear camper section drive shaft 45 slides approximately twelve inches. The rear drive shaft 44 of the frontal vehicle is designed to connect to the coupling 50 and a release mechanism located on the coupling 50 permits easy attachment and detachment. A bearing assembly (not pictured) is located on the end of the rear drive shaft 44 of the frontal vehicle to reduce friction between the various moving parts. Obviously, the coupling attachment could be reversed such that the coupling would be located on the rear drive shaft of the frontal vehicle rather than the rear camper section drive shaft.

The components Cocoon Camper may vary widely but will likely utilize metal, plastic, rubber, canvas, glass and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Cocoon Camper can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

The size of Cocoon Camper may vary widely. The preferred embodiment is approximately ten to fourteen feet in height, thirty to forty-five feet in length, and six feet and six inches in width. It should be obvious that any camper shape or color could be utilized. It should also be obvious that any suitable vehicle, including a van, can be used as the frontal vehicle with the present invention.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A two-unit camper comprising:
(a) a frontal vehicle;
(b) a rear camper section;
(c) an attaching mechanism connecting the frontal vehicle and the rear camper section;
(d) a lifting mechanism for retracting a set of rear wheels on the frontal vehicle; and
(e) a front drive shaft on the frontal vehicle that connects to a modified differential of the frontal vehicle and a rear drive shaft on the frontal vehicle that connects on one end to the modified differential of the frontal vehicle and on the other end to a drive shaft on the rear camper section.

2. The two-unit camper of claim 1 wherein the rear camper section overlaps the top of the frontal vehicle.

3. The two-unit camper of claim 1 wherein the frontal vehicle is a van.

4. The two-unit camper of claim 1 wherein the top of the rear camper section is made of canvas.

5. The two-unit camper of claim 4 wherein the top of the rear camper section is operatively connected to a hydraulic cylinder.

6. The two-unit camper of claim 4 wherein the top of the rear camper section is operatively connected to an air cylinder.

7. The two-unit camper of claim 1 further comprising
an air vent in the top of the rear camper section.

8. The two-unit camper of claim 1 wherein the attaching mechanism utilizes at least one support rod connected on one end to the rear camper section and on the other end to a rack located on top of the frontal vehicle.

9. The two-unit camper of claim 1 wherein the attaching mechanism has a metal bar attached on one end to the rear of the frontal vehicle and on the other end to the front of the rear camper section and further has a chain attached on one end to the front of the rear camper section and on the other end to a hook on the metal bar.

10. The two-unit camper of claim 1 wherein the lifting mechanism is a gear box connected to a bearing located on a rear axle of the frontal vehicle and wherein the gear box connects to at least one air cylinder attached to the frontal vehicle.

11. The two-unit camper of claim 1 wherein the modified differential includes a selector to activate the set of rear wheels on the frontal van.

12. The two-unit camper of claim 1 wherein the modified differential includes a selector to activate a second set of wheels on the rear camper section.

13. The two-unit camper of claim 1 further comprising
an electrically activated brake installed on the rear camper section.

14. The two-unit camper of claim 1 wherein the drive shaft on the rear camper section is slidable.

15. The two-unit camper of claim 14 wherein a coupling is located on the drive shaft on the rear camper section.

16. The two-unit camper of claim 15 wherein a release mechanism is located on the coupling.

17. The two-unit camper of claim 1 wherein a bearing is located on the rear drive shaft on the frontal vehicle.

18. A two-unit camper comprising:
(a) a frontal van;
(b) a rear camper section that overlaps the top of the frontal van and has a canvas top operatively connected to a hydraulic cylinder and having an air vent;
(c) an attaching mechanism connecting the frontal van and the rear camper section wherein the attaching mechanism utilizes at least one support rod connected on one end to the rear camper section and on the other end to a rack located on top of the frontal van and wherein the attaching mechanism further has a metal bar attached on one end to the rear of the frontal van and on the other end to the front of the rear camper section and further has a chain attached on one end to the front of the rear camper section and on the other end to a hook on the metal bar;
(d) a gear box connected to a rear axle of the frontal vehicle that is attached to at least one bearing and wherein the gear box is connected to at least one air cylinder attached to the frontal van; and
(e) a front drive shaft on the frontal vehicle that connects to a modified differential on the frontal vehicle wherein the modified differential includes a selector to activate a first set of wheels on the frontal van and a second set of wheels on the rear camper section;
(f) a rear drive shaft on the frontal vehicle that connects on one end to the modified differential of the frontal vehicle and on the other end to a drive shaft on the rear camper section;
(g) an electrically activated brake installed on the rear camper section;
(h) said rear drive shaft on the frontal vehicle having a bearing; and
(i) said drive shaft on the rear camper section being slidable and having a coupling with a release mechanism.
